(19) United States
(12) Patent Application Publication
(10) Pub. No.: US 2008/0276898 A1
(43) Pub. Date: Nov. 13, 2008

(54) High fuel efficiency flywheel and cylinder internal cambustion engine hybrid (abbreviated as F&C engine hybrid)

(76) Inventors: Tse-Cheng Wang, Hsin Tien (TW); Ming Wang, Hsin Tien (TW)

Correspondence Address: TSE-CHENG WANG, 1 F. NO. 23 LANE 196 PEI HSIN ROAD, SECTION 2, HSIN TIEN, TAIPEI, 231, TW

(21) Appl. No.: 11/801,117

(22) Filed: May 9, 2007

(51) Int. Cl. F02B 75/06; F16D 3/10

(52) U.S. Cl. 123/192.2; 123/197.3; 74/572.2

(57) ABSTRACT

F&C engine includes a central shaft mounted a cylindrical cam, that formed with two pieces of different diameter steel tubes, as the inner and outer walls, the upper end of the outer wall, placed a driving flange, to drive the engine timing devices. on the two layer walls (for light duty or small engine the single layer wall is acceptable) with pairs of peak and valley channel, a overdrive clutch; inside the cam contained a dynamotor to form a hybrid; a magnetic clutch, for engaging or disengaging the cylindrical cam; a driving plate for driving the devices that not related to the engine timing; a cylinder to produce power and transfer the power to the cam through a push rod; a guide plate to guide the push rod; many support rollers for supporting the cam; a tubular case with foot for contain and support the engine.

### BACKGROUND OF THIS INVENTION

Since more than 100 years of times, people are perplexed by how to raise the fuel efficiency of the internal combustion engines. In the present time, the shortage of petrol-oil, the pollution of environment, the green house effect and weather change that becomes warmer and warmer. Such effects are a part from the emissions of our everyday popular used of the very low fuel efficiency internal combustion engines, such as the cars, ships and heavy duty equipments etc. Some bodies have clamoring to decrease the co2, In such a case, It really need an higher fuel efficiency engine to solve the very important problems of the world urgently. If we can invent a new engine, that can eliminate the causes, that makes the fuel efficiency is very low of the reciprocating and rotary (Wankel's) engines, a part of the dilemmas of the world will be reduced.

By a long time to study and research, I have been discovered the real causes, that makes the very low efficiency of the reciprocating and rotary (Wankel's) engines, and have been invented a new high fuel efficiency F&C engine hybrid. The most important causes that make the reciprocating and rotary engines fuel efficiency very low are as follows:

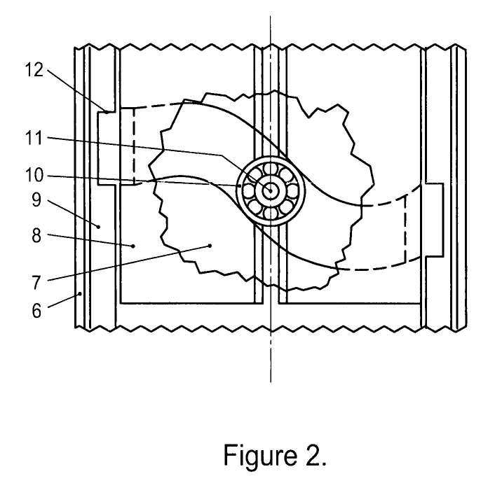

A. The causes that makes the very low efficiency of the reciprocating engine:
(1) The effective arm is variable during the engine is running:
   When the piston on the TDC the effective arm=0, when θ=90 degrees, the effective arm is the longest, equal to the length of the crank arm, when the θ is bigger than 90 degrees, the effective arm will become shorter again, when θ=180 degrees the effective arm=0 again. During this variation it makes a big loss.
(2) The pressure and the effective arm are in the worst match:
   When the pressure is higher or highest, the effective arm is very short or equal 0 (when the piston on TDC and BDC); when the effective arm is longer or longest (equal to the length of the crank arm) the pressure is very low. The proof is as the flowing:
   For instance: W=M×θ in this formula “M” (moment) is the very important element, M=F×rₑ, the “F” is the total pressure on the piston top, (please to make a reference to attached FIG. 2) rₑ is the effective arm on the same point, r is the length of the crank arm, On an explosion curve char, that is to place many points along the explosion curve, the points are representing the pressure and related angle θ on that point, we give the related parts with numbers, the numbers will tell us the truth. To select the point 1200 psi, the area of piston top is 1 square in. the total pressure on the piston top is 1200×1=1200 lb; the length of the crank arm is 0.5 ft; the 1200 psi pressure almost occurs on θ=10 degrees, the effective arm rₑ=r×sin. θ, then 0.5×sin. 10=0.087 ft. that is when on the point 1200 psi, the effective arm is 0.087 ft; When, the 1200 psi almost the highest pressure, but the effective arm only 0.087 ft. is very short, it is the worst match, when θ=90 degrees the effective arm is the longest, rₑ=r=0.5 ft. the pressure on the piston top becomes much lower, about 70 psi. It is the worst match.
(3) Due to the process of effective arm variation and worst match of force and effective arm, that makes a big loss of “M” (moment) in percentage: We still to select the point 1200 psi. The real moment: 1200×0.087=104.4 ft-lb. It should have moment: When the rₑ=r=0.5, the M=1200×0.5=600 ft-lb. 600/100=6%, 104.4/6=17.4%, 100−17.4=82.6%.That means the loss is 82.6%. It is really very big.
(4) No matter how long to elongate the length of the crank arm, the loss of “M” in percentage is the same:
   We elongate the length of crank arm from 0.5 ft. to 1 ft. Still to select the same point 1200 psi. θ=10 degrees, re=1×sin. 10=0.174 ft. M=1200×0.174=208.8 ft-lb. If the effective arm is not varied, re=r, =1, M=1200×1=1200 ft-lb., 1200/100=12%, 208.8/12=17.4%, 100−17.4=82.6%. the loss is all the same.
(5). To elongate the length of crank arm that have to increase the counterweight to balance the unbalance:
   The counterweight needs some energy to make it running, it is also a loss.
(6). The ignition before TDC:
   It is also a loss, because the pressure on the piston top before TDC. is the load of the engine; after the TDC is the work of the engine.
(7). The compression and explosion impacting surface of the piston:
   It is a loss, because it can produce a big friction.
(8). The inertia of the piston and connecting rod:
   Because when the inertia before BDC. Is the work of the engine; after BDC. It becomes a load of the engine, it is a loss.
(9). When, in low rpm. the reciprocating engine has no enough torque and horse power, for getting enough torque and horse power, have to accelerate the engine to 3000 to 5000 rpm. or more, may approach the enough torque and horse power, for starting or moving the car, that have to consume much fuel, it is also a loss.
B. The causes that makes the very low efficiency of rotary (Wankel's) engine:
(1). The pressure distribution:
   The pressure inside the explosion chamber, a part of the pressure turns the triangle piston to one direction; the other turns the triangle piston to the reverse direction, only the difference of the pressure turns the triangle piston running,(please to make the attached reference FIG. 3) and the difference is varied from strong to weak. This fact is fixed can not be improved.
(2). The effective arm:
   The effective arm of this engine is related to the radius of the central axle, this radius can not be too big, say as 1 ft. that will make the engine tremendous and big weight. The efficiency of this engine is very low as the reciprocating engine.
(3). The driving and driven:
   The pitch diameter of the ring gear at the central part of the triangle piston, always bigger than the central axle gear pitch diameter, that is the big gear to drive the small gear, that have to make a loss.

### THE DETAILED DESCRIPTION

The figures:

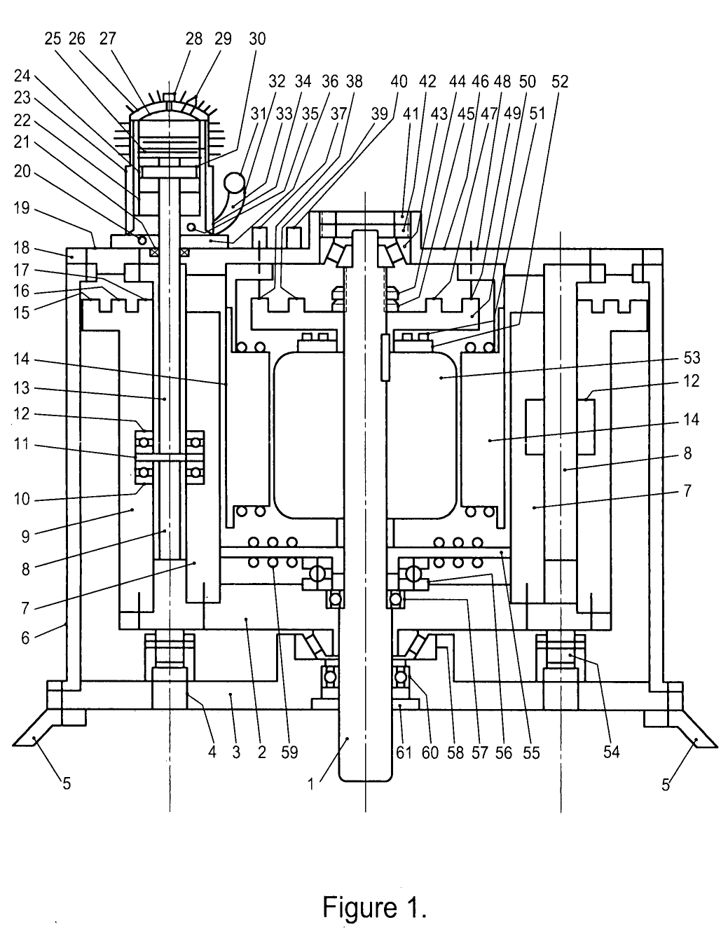

FIG. 1. is the vertical section of the hybrid.

FIG. 2 is the peeled section of the channel inclined surface, the bearings and pin.

The attached figures.

The descriptions with the numbered embodiments (please to make a reference to FIG. 1.):

### THE DESCRIPTION

Numbers:
1. The central axle: it bears the parts: the cylindrical cam (flywheel, it constructed of the parts in item 2); 55.magnetic clutch;58. armature;50.driving plate.
2. The bottom plate of the cylindrical cam: it mounted with 7.inner wall, 9. the outer wall with flange, 56.thrust bearing.57.overdrive clutch.
3. Bottom plate of the engine case: it mounted 54.supporting rollers 58. Bevel roller bearing.60 roller bearing, 61.oil seal.
4. The connecting bolts.
5. The foot.
6. The tube of the engine case.
7. The inner wall that mounted on the 2.bottom plate of cylindrical cam.
8. The channel guiding plate mounted on the 18. upper plate of the engine case.
9. The outer wall mounted on the 2.bottom plate of cylindrical cam.
10. The roller bearing insert into the curved channels on the inner and the outer walls.
11. The pin of the roller or ball bearings.
12. The curved channels, carved on the inner and outer walls of cylindrical cam, this curved channels are carved with many pairs of peak and valley, the peak as the TDC, the valley as the BDC. as in the reciprocating engine. One cylinder can act on many pairs of peak and valley, that is in one cylinder engine, in one revolution can have many explosion strokes, the pairs of peak and valley, can give cylinder function or say, can replace cylinder, for it can give a explosion stroke it may make one cylinder acting on many pairs of peak and valley, or many cylinders acting on many pairs of peak and valley, the cylinders may ignite in the same time, that will give a bombard function.
13. The pushing rod that transfer the force from piston to the roller or ball bearings.
14. The exciting magnetic field for the armature (dynamotor).
15. The curved lumpy strips to operate the 19.ignition stem.
16. The curved lumpy strips to operate the injecting pump.
17. The curved lumpy strips to operate 27.valve.
18. The upper plate of the engine case, it is opened many holes for installing the devices, especially, the center of this plate is a hole, inside this hole to contain 41.lock nut, 42 adjusting nut, 43 bevel bearing, they are holding the 1. central axle in its right position.
19. The ignition stem.
20. The lubricant return hole.
21. The oil and Air seal.
22. The sleeve of the cylinder.
23. The cylinder.
24. The Air or mixture inlet holes.
25. The piston rings.
26. The cylinder head
27. The valve.
28. The nozzle.
29. The spark lug.
30. The piston pin.
31. The Air cleaner or carburetor.
32. The inlet manifold.
33. The butterfly valve.
34. The inlet check valve.
35. The lubricant injecting holes.
36. The safety vale. when the lubricating system have troubled, the lubricant stored in the chamber under the piston, the pressure will be raised to open this vale, to let the lubricant leak into the engine case.
37. The Air compressor.
38. The arced lumpy strips to operate the Air compressor.
39. The arced lumpy strips for operating cooling media compressor.
40. The cool media compressor.
41. The lock nut.
42. The adjust nut.
43. The bevel roller bearing.
44. The lock nut.
45. The adjust nut.
46. The needing accessories.
47. The arced lumpy strips, for operating the needing accessories.
48. The needing accessories.
49. The arced lumpy strips.
50. The driving plate.
51. The slipping rings for the magnetic clutch.
52. Commutator for the armature.
53. The armature (dynamotor).
54. The supporting rollers.
55. The magnetic clutch.
56. The thrust bearing.
57. The overdrive clutch.
58. The bevel roller bearing.
59. The electrical wires.
60. The roller bearing.
61. The oil seal.

The synopsis of sharp contrast of losses and causes of the reciprocating engine between the F&C Engine.
Reciprocating engine. [symbol] F&C engine.
1. The effective arm is variable during the engine is running:
   In reciprocating engine:
      When the piston on the TDC the θ=0, the effective arm=0, when θ=90 degrees, the effective arm is the longest equal the length of the crank arm, when the θ is bigger than 90 degrees the effective arm will begin shorter, when θ=180 degrees the effective arm=0 again. During this variation it makes a big loss.
   [symbol] In F&C engine:
      The effective arm is not variable during the engine is running, because, the effective arm of this engine is the radius of the cylindrical cam, it is no loss.
2. The pressure and the effective arm are in the worst match:
   In the reciprocating engine:
      When the pressure is higher or highest, the effective arm is very short or equal 0, when the piston on TDC.; when the effective arm is longer or longest the pressure is very low
   The proof:
   For instance, W=M×θ, in this formula “M” (moment) is the very important element, M=F×re, the F(pressure) is the total pressure on the piston top, re is the effective arm, r is the length of the crank arm, On the explosion curve chart (please make a reference FIG. 2 in the attached referent figures), that is to place many points along the explosion curve, the points are to represent the pressure and the related angle θ, on that point, we give the related parts with numbers, the numbers will tell us the truth. To select the point 1200 psi, the area of piston top is 1 square in. the total pressure on the piston top is 1200×1=1200 lb; the length of the crank arm is 0.5 ft; the 1200 psi pressure almost occurs on θ=10 degrees, the effective arm rₑ=r×sin. θ, then, 0.5×sin. 10=0.087 ft., that is when on the point 1200 psi, the effective arm is 0.087 ft; When θ=90 degrees the effective arm is the longest rₑ=0.5×1=0.5 ft. the pressure on the piston top becomes much lower about 70 psi. It is a worst match. It makes a big loss.
   [symbol] In the F&C engine:
      The pressure and the effective arm are no unbreakable relations, no questions of match. No loss.
3. During this process of effective arm variation and worst match of force and effective arm, it makes a big loss of “M” (moment) in percentage:
   In the reciprocating engine:
      Illustrations: (please to make a reference to the above item 2 of the * reciprocating engine)
      the moment=1200×0.087=104.4 ft-lb. When the rₑ=r=0.5, the m=1200×0.5=600 ft-lb. 600/100=6%, 104.4/6=17.4%, 100−17.4=82.6%. That means the loss is 82.6%. It is really very big.
   [symbol] In F&C engine:
      The effective arm is the radius of the cylindrical cam of this engine, it can not be varied, the effective arm and the force no unbreakable relations. It is no loss. But, some force (pressure) discount or loss may need to study:
      Ft=p/tan. θ, the discount according the angle θ, when θ=45 degrees, Tan. 45=1, that is no discount or loss; (please to make a reference to the attached reference FIG. 1.) when one force act on a inclined surface, the inclined surface and the horizon made an angle φ, φ=90−θ, the Ft=p/tan. θ, when the θ=45 degrees the Ft=p×1=p; But in some cases the angle θ and φ may be adjusted, and the angle θ and φ are the supplementary angles, they are related to the Ft and s_{d}, (displacement) that need carefully to design according to the purpose of use.
4. No matter, how long to elongate the length of the crank arm the loss of “M” (moment) in percentage is the same:
   In the reciprocating engine:
      We elongate the length of crank arm from 0.5 ft. to 1 ft. Still to select the same point 1200 psi. θ=10 degrees,
      rₑ=1×sin. 10=0.174 ft. M=1200×0.174=208.8 ft-lb
      If the effective arm is not varied, rₑ=r,
      M=1200×1=1200 ft-lb. 1200/100=12%,
      208.8/12=17.4%, 100−17.4=82.6% it is all the same.
   [symbol] In F&C engine
      The crank arm of this engine is the radius of the cylindrical cam, to increase the radius can increase the torque and horse power, no loss.
5. To elongate the length of crank arm have to increase the counterweight:
   In the reciprocating engine:
      It have to have a counterweight to balance the unbalance that have to consume some energy to make it running, it is also a loss.
   [symbol] In F&C engine:
      In this engine do not need a counterweight, because, the unbalance can adjust by cutting steel material of the cylindrical cam, no loss.
6. The ignition before TDC:
   In the reciprocating engine:
      It is also a loss, because the pressure on the piston top, before TDC. is the load of the engine; after the TDC is the work of the engine.
   [symbol] In F&C engine
      In F&C engine the ignition timing is according to the length of a section of the curve, when the piston on TDC. it has a long range for adjusting. To ignite at any where can make the end bearing always on the inclined surface, to push the cam running. No loss.
7. The compression and explosion impacting surface of the piston:
   In the reciprocating engine:
      It is a loss, because it can produce a big friction.
   [symbol] In F&C engine
      In F&C engine the pushing rod is straight no swing, it can not be occurred such a case. no loss
8. The inertia of the piston and connecting rod:
   In the reciprocating engine:
      It is a loss, because when the inertia before BDC. Is the work of the engine; after BDC. It becomes a load of the engine.
   [symbol] In the F&C engine:
      When the exhaust valve is opened the pushing rod end bearing still on the curve to push the cylindrical cam to running, to consume the inertia to become work. That is not a loss.
9. At low rpm no enough torque and horse power to start or move the car or an equipment for running:
   In reciprocating engine:
      For getting to the enough torque and horse power to start or move the car running, have to accelerate the engine to 3000 to 5000 rpm, or more, that is also a loss.
   [symbol] In F&C engine:
      In F&C engine at low rpm can give enough torque and horse power to start or move the car running, as in 500□1000 rpm. the loss relatively smaller
10. The displacement relates the stroke, bore and the angle φ:
   In the reciprocating engine:
      The stroke and bore have no much relation to the displacement, and it is fixed because the stroke always equal 2 times of the length of the crank arm.
   [symbol] In F&C engine:
      Sd=the displacement, ss=the stroke, φ=the angle makes by the inclined surface and the horizon. Sd=ss/tan. φ. if the angle φ is constant, when the stroke ss is longer will make the displacement Sd longer, The above mentioned elements are adjustable. We may make our choice according to the purpose of use. To make the stroke longer can make the displacement longer and combustion better, because can get longer time for burning. If the capacity of the cylinder is constant, to elongate the stroke will make the bole smaller, it will reduce the piston top area and total pressure. The displacement and the total pressure, we may make a choice according to the purpose of use.
11. The comparisons of main parts and accessories are retrenched:
   For example: one 100 horse power engine:
   (1). The cylinders:
      (a). The cylinder capacity of the engine:
      In the reciprocating engine:
         In 100 horse power engine the capacity of the engine is around 2000 cc.;
      [symbol] in F&C engine only 1000 cc is enough. It retrenches 1000 cc.
      (b). The number of cylinders and its related parts:
      In the reciprocating engine:
         At least needs 4 cylinders and its related parts.
      [symbol] in F&C engine:
         Only one cylinder is enough. That retrenches 3 cylinders and the related parts—3 cylinder heads, 3 sets of valves and its operating devices, 3 nozzles, 3 spark plugs, 3 pistons with rings and piston pins, 3 connecting rods with the bushing of the piston pins, the cell bearings and a section of crank shaft.
   (2). The crank shaft:
      In reciprocating engine:
         To fabricate a crank shaft needs forging or casting and machine works.
      [symbol] in F&C engine:
         to fabricate a 2 ft. diameter cylindrical cam only need 2 sections of steel pipe, a piece of steel plate and machine work, it is much cheaper than a 4-cylinder crank shaft.

Statements and Operations of F&C Engine Hybrid:
The statements:
The features of this engine are in low rpm. can give enough torque and horse power; the pairs of peak and valley can replace the cylinders, that saved many cylinders for the engine. The cylinder cycle of F&C engine is using two cycle operating, when the piston goes upper ward, the air goes into the under piston chamber first, when the piston goes downward to compress the air, when the exhaust valve is opened, the inlet holes are disclosed the air come into the Cylinder to scavenge the burn gas out, the piston still goes down continually, to consume the inertia energy, the inertia energy will become work, because in the same time the pushing rod end bearing still on the curve or inclined surface, to push the cylindrical cam to running. The exhaust valve may close earlier, to make the air is still compressing, to increase the density to the air inside the cylinder, to have a turbo-charge function. The curved channel of the cylindrical cam is carved of many pairs of peak and valley, the peak point is the piston on TDC. The valley is the BDC. Along the circumference of cylindrical cam, we can carve many pairs of peak and valley, that unlike the reciprocating engine, one cylinder engine, in one revolution, can produce only one explosion stroke; the one cylinder F&C engine, in one revolution, can produce many explosion strokes. that can make the average effective pressure higher and save cylinders.
The operation of the F&C engine hybrid:
To start the engine and drive the car with engine:
To operate the field exciting switch to the high position, to push the motor starting button, to let the motor running in the normal condition, to turn the magnetic clutch switch on, to drive the engine to star. When the engine is started, release the baton, to operate car driving clutch and the transmission to drive the car running. The engine drives the central axle and the armature. To adjust the current of the field exciting current can adjust the generator output.
To drive the car with motor:
To operate the engine injecting, accelerating and fuel control device to stop the engine, let it standby, push the motor starting button, adjusting the field exciting current, to the normal motor running condition, to operate car running clutch and the transmission to drive the car running. It can drive the car with the engine and motor together, that needs to adjust and control the engine and the motor control devices.
The brake functions with the engine and motor:
When the car is driven by the engine, to operate the field exciting switch to the full current position, to make the generator in full load to get the big resistance to help the brake.
When the car is driven by the motor:
To push the magnetic clutch button to engage the engine to increase the resistance to help the brake.

If make the engine with no hybrid part:

That needs to key the cam to the central axle, remove the overdrive clutch, the magnetic clutch, the driving flange. That makes the engine much simpler, and cost cheaper.

The living examples of KAWASAKI—FT-22 (a small reciprocating engine) and the F&C engine.

The specification of KAWASAKI—FT-22 (please see the attached reference figure)

The main specification of the F&C engine:
The cylinder is moved from the KAWASAKI—FT-22. Bore: 31 mm. 1.220 in. 0.102 ft.; Area of piston top: 7.544 square cm. 1.170 square in. Stroke: 30 mm. 1.181 in. 0.098 ft.; Diameter of the cylindrical cam: 160 mm. 6.299 in. 0.525 ft.; Radius of the cylindrical cam: 80 mm. 3.150 in. 0.262 ft.; Circumference: 502.655 mm. 19.790 in. 1.650 ft. θ=55 degree.

To compare the out put between the KAWASAKI—FT-22 and F&C engine:
HP=w/33000, w=m×θ, m=F×r, θ=2π×(rpm).
The HP of KAWASKI—TF-22 is 0.8 hp. at 7000 rpm. as shown on the specification. of KAWASAKI—TF-22.
The HP of the F&C engine will be as follows:
We give average effective pressure is as low as 50 psi. rpm=500 50×1.17=58.5 lbs. 58.5/tan. 55=40.966 lbs. (discounted). M=40.966×0.262=10.740 ft.-lb. θ=2π×500=3141.593. w=10.740×3141.593=32430.661. HP=33740.709/33000=1.022
This is one revolution only one explosion stroke. But actually this engine has an ability to give 4 explosion strokes, just because the magneto only one igniting point, only can have one ignition in one revolution.
The relations between parts to parts are adjustable, if, when the θ is 45 degrees; the explosion strokes are 4 in one revolution; the effective pressure is 100 psi. That will make the HP much bigger:
HP=w/33000, the total pressure on one piston top: 100×1.17=117 (tan. 45=1, no discount)
M=117×4×0.262=122.616 ft.-lb (4 explosion strokes in one revolution).
Θ=2π×500=3141.593 W=3141.593×112.616=353793.637 ft.-lb.
HP=353793.637/33000=10.721 The 10.721 HP need 2000 explosion strokes 7000−2000=5000 explosion strokes is saved, 10.721−0.8=9.921 HP is plus the fuel efficiency, I think it will be more than 70%.

### THE SUMMARY OF THIS INVENTION

1. In accordance with the above statements, we understand obviously that we can not to overcome the inherent faults, especially, it can not use the effective arm plenty, and the match of the effective arm and the force better, in the reciprocating engine; and can not improve the pressure distribution and the effective arm bigger, in rotary engine. So, we can not make the fuel efficiency higher of this engines, the mentioned engines have to be replaced by F&C engine. The F&C engine can retrieve the losses of the reciprocating and rotary engines, when θ=45 degrees, it is no loss, the fuel efficiency must be too much bigger than the reciprocating and rotary engines, the fuel efficiency may as high as 70% or more, by evaluating, calculating and testing, primarily.
2. The F&C engine is no inherent faults as the mentioned engines, it can use the effective arm plenty, to reduce rpm, the pairs of peak and valley can replace the cylinders of the engine, that is reduced cylinders of the engine. The rpm comes from the fuel; the effective arm is made of a piece of steel, the fuel is consumed very easy; to consume the steel needs a longer time; in F&C engine, between the parts to parts or device to device are adjustable, so, its fuel efficiency can be made as higher as around 70%, or more, that may approach the goal 100 mpg. The advantages of the F&C engine are that in low rpm. can give big torque and horse power; the structure is much simpler than the mentioned engines, it can save fabricating cost;
   The inner chamber of the cylindrical cam is large enough, for placing an armature; the cylindrical cam and the armature mounted on same axle, when apply the engine and motor to drive the car together, can make the rpm of the engine and the armature run synchronously, the motor may controlled by adjusting the field exciting current, and no complex couplings and belts, it will be no loss of slipping; The driving plate can make the devices to go reciprocating, better than the rotating with the ring gears; the theory of the F&C engine hybrid is tenable and the parts are machinable. It is tangible, the high fuel efficiency F&C engine hybrid be ready, this engine has been tested primarily, I hope it will be serving for the people in the world, to solve a part of the world dilemmas.

I claim:

1. A high fuel efficiency flywheel and cylinder internal combustion engine hybrid, it has the features that in low rpm. can give enough torque and horse power, the pairs of peak and valley, locate at the walls of the cylindrical cam can give a function to replace cylinders, for reducing the engine's cylinders, the inner space of the cylindrical cam is enough to contain an armature( dynamotor), the mine parts of this hybrid includes: one central axle mounted or keyed magnetic clutch, a flywheel (cylindrical cam), an armature(dynamotor) with commutator, a driving plate, a pair of slipping rings, a cylinder or cylinders and its related members, a channel guiding plate, an engine case with foot.

2. A hybrid as defined in claim 1. The magnetic clutch is operated with current, the current supplied from the slipping rings through the carbon brushes and wirings, controlled with a button switch on operating panel, when the current is acting in the coil of the magnetic clutch, to produce magnate on the ends of the iron core, it will engage the inner wall of the cylindrical cam (the engine) with magnate, to drive the cylindrical cam, to start the engine. (the power is the dynamotor used as the starting motor.)

3. A hybrid as defined in claim 1. The flywheel (cylindrical cam) is composed of a bottom plate, on the center of this plate is mounted an over drive clutch, when the engine is started, the engine drives the central axle and the armature running, the car moving, when the engine is stopped, using the motor drives the car, the engine can stand by; the outer and inner walls (a single wall may acceptable for the light duty) with curved channels, the curved channels are made with pairs of peak and valley, the peak and valley as the TDC and BDC in reciprocating engine, that can one cylinder match many pairs of peak and valley, that in one cylinder engine, in one revolution can give many explosion strokes, or one pair of peak and valley matches many cylinders, or many cylinders match many pairs of peak and valley, that can make the all cylinder to ignite in the same time, to produce a bombard function, on the top of outer wall provided a driving flange, with curved lumpy strips, to drive the accessories that related to the engine timing.

4. A hybrid as defined in claim 1. The armature is a dynamotor when supplying with current it is a motor, when driving by the engine it is a generator, controlled by adjusting the exciting current of the field,

5. A hybrid as defined in claim 1. The slipping rings are contacted with carbon brushes and wirings to lead the current to the magnetic clutch.

6. A hybrid as defined in claim 1. The driving plate, on this plate mounted many curved lumpy strips, for driving the accessories that are not related to the engine timing.

7. A hybrid as defined in claim 1. The cylinder and the related parts and devices, a cylinder head mounted with nozzle, spark plug, valve and the acting mechanisms to the valve, include the device that can make the valve on open position, to release the pressure, for easy to start, a set of piston includes rings, piston pin, pushing rod and a bottom end pin, the pin is mounted roller or ball bearings, on the both ends of this pin, the bearings are inserting into the curved channels that located at the inner and outer walls of the cylindrical cam, many lubricating holes are provided under the sleeve, that can inject and spread the lubricant to the wall of the sleeve of the cylinder, at the near bottom of the sleeve, there are several holes to let the compressed air come into the cylinder's sleeve, to scavenge the burn gas, when the exhaust valve is opened, a release valve is provided, for when the lubricant system occurs troubles, the lubricant stored too much, inside the chamber under the piston, to release the lubricant into the engine case, an in let manifold with check and butterfly valves, or with carburetor for leading the air or mixture into the chamber under the piston, and use the check valve to sop the air or mixture goes back.

8. A hybrid as defined in claim 1. The channel guide plate that is to guide the pushing rod in its right position, the holding holes on this channel guide plate may round or square, at the holes inner surface may insert many steel balls for reducing the friction.

9. A hybrid as defined in claim 1. The engine case, that includes the bottom plate, in the center part of this plate has a hole for holding the roller, bevel roller, thrust bearings and over drive clutch, under the outer near the circumference of this plate, mounted many supporting rollers, for supporting the cylindrical cam, to keep it in its right position, if need to place the engine in horizon, it needs some side supporting rollers, around the surface of the outer wall, to hold the cylindrical cam, a body tube is provided, on the both ends of this tube have flanges with holes, for screwing to the upper and the lower plates, an upper plate, on this plate placed many holes for install cylinders, needed devices, and holding bevel roller bearing in the center position, several foot are provided for supporting engine, the foot may make according to the purpose of use,
